(19) United States
(12) Patent Application Publication
(10) Pub. No.: US 2020/0341403 A1
(43) Pub. Date: Oct. 29, 2020

(54) CHARGING DEVICE, PROCESS CARTRIDGE, AND IMAGE FORMING APPARATUS

(71) Applicant: FUJI XEROX CO., LTD., Tokyo (JP)

(72) Inventors: Yasuhiko KINUTA, Kanagawa (JP); Kosuke NARITA, Kanagawa (JP); Keiko MATSUKI, Kanagawa (JP)

(73) Assignee: FUJI XEROX CO., LTD., Tokyo (JP)

(21) Appl. No.: 16/724,643

(22) Filed: Dec. 23, 2019

(30) Foreign Application Priority Data
Apr. 23, 2019 (JP) 2019-081916

(51) Int. Cl. G03G 15/02

(52) U.S. Cl. CPC G03G 15/0266; G03G 15/0233

(57) ABSTRACT

A charging device includes: a charging member that charges an electrophotographic photoconductor by a contact charging method and includes a conductive substrate, an elastic layer provided on the conductive substrate, and a surface layer that is provided on the elastic layer and contains irregularities-forming particles that have a number particle size distribution with two or more maximum values when observed, from a surface of the surface layer, and a voltage application unit that applies, to the charging member, an AC voltage superimposed on a DC voltage.

### CROSS-REFERENCE TO RELATED APPLICATIONS

This application is based on and claims priority under 35 USC 119 from Japanese Patent Application No. 2019-081916 filed Apr. 23, 2019.

### BACKGROUND

### (i) Technical Field

The present disclosure relates to a charging device, a process cartridge, and an image forming apparatus.

### (ii) Related Art

An image forming apparatus using an electrophotographic system performs a process that includes first forming electric charges on the surface of an electrophotographic photoconductor including an inorganic or organic photoconductor using a charging device, forming an electrostatic latent image using, for example, laser beams modulated with image signals, and then developing the electrostatic latent image with charged toner to form a visible toner image. The toner image is then electrostatically transferred to a transfer material such as a recording sheet directly or via an intermediate transfer body, and fixed on the recording material to form a reproduced image.

JP-A-2010-078741 discloses a conductive roll that includes at least a shaft a semiconductive elastic layer provided on an outer periphery of the shaft, and an outermost layer, Under an applied voltage, the conductive roll is brought into contact with an object to charge the object. The conductive roll has an image area and a non-image area, in which the surface roughness of the outermost layer in the image area is different from the surface roughness of the outermost layer in the non-image area.

JP-A-2008-015323 discloses a charging device including a charging member that charges an object under a voltage applied between the charging member and the object when brought into contact with the object, in which the charging member is in the form of a roll including a metallic core, a semiconductive layer on the metallic, core, and at least one upper layer on the semiconductive layer, and the charging member satisfies 30 μm≤RSm≤320 μm and 1.1 μm≤Rz≤5 μm wherein RSm represents the distance between irregularities on the surface of the charging member, and Rz represents the ten-point average surface roughness of the surface of the charging member.

JP-A-2011-013462 discloses a charging member including a conductive core, a charging layer formed on the conductive core, and a surface layer, in which the surface layer has recessed and raised portions, and the raised portion has a smooth portion”.

JP-A-2018-060162 discloses a charging roll for electrophotographic equipment including a shaft, an elastic layer formed on an outer periphery of the shaft, and a surface layer formed on an outer periphery of the elastic layer, in which the surface layer contains a binder resin, large particles having an average particle diameter of 15 μm to 50 μm, and small particles having an average particle diameter of 3 μm to less than 15 μm. the content of the small diameter particles is in the range of 5 to 50 parts by weight based on 100 parts by weight of the binder resin, and particle aggregates including the small diameter particles in the surface layer have a size of 6 μm to 50 μm.

A charging member having irregularities on its surface may be used in a charging device that applies, to the charging member, an AC voltage superimposed on a DC voltage and charges the surface of the electrophotographic photoconductor by a contact charging method. In such a case, contaminants on the electrophotographic photoconductor may migrate to the charging member to cause streaks on images or wear of the surface of the electrophotographic photoconductor.

### SUMMARY

Aspects of non-limiting embodiments of the present disclosure relate to providing a charging device that has a charging member including a conductive substrate, an elastic layer provided on the conductive substrate, and a surface layer provided on the elastic layer and having surface irregularities and applies, to the charging member, an AC voltage superimposed on a DC voltage to charge the surface of an electrophotographic photoconductor by a contact charging method, in which streaks on images and wear of the surface of the electrophotographic photoconductor are less likely to occur than in a case where irregularities-forming particles in the surface layer of the charging member have a number particle size distribution with a single maximum Value when viewed from the surface of the surface layer or a case where irregularities-forming particles in the surface layer of the charging member only have a small volume average particle diameter or only have a large volume average particle diameter.

Aspects of certain non-limiting embodiments of the present disclosure address the above advantages and/or other advantages not described above However, aspects of the non-limiting embodiments are not required to address the advantages described above, and aspects of the non-limiting embodiments of the present disclosure may not address advantages described above.

According to an aspect of the present disclosure, there is provided a charging device including: a charging member that charges an electrophotographic photoconductor by a contact charging method and includes a conductive substrate, an elastic layer provided on the conductive substrate, and a surface layer that is provided on the elastic layer and contains irregularities-forming particles that have a number particle size distribution with two or more maximum values when observed from a surface of the surface layer; and a voltage application unit that applies, to the charging member, an AC voltage superimposed on a DC voltage.

### BRIEF DESCRIPTION OF THE DRAWINGS

Exemplary embodiments of the present invention will be described in detail based on the following figures, wherein:

FIG. 1 is a schematic perspective view illustrating an example of a charging device according to an exemplary embodiment;

FIG. 2 is a schematic perspective view illustrating an example of a charging member in the exemplary embodiment;

FIG. 3 is a schematic configuration diagram illustrating an example of an image forming apparatus according to the exemplary embodiment;

FIG. 4 is a schematic configuration diagram illustrating another example of an image forming apparatus according to the exemplary embodiment;

FIG. 5 is a schematic configuration diagram illustrating another example of an image forming apparatus according to the exemplary embodiment; and

FIG. 6 is a schematic configuration diagram illustrating an example of a process cartridge according to the exemplary embodiment.

### DETAILED DESCRIPTION

Hereinafter, exemplary embodiments of the disclosure will be described. The descriptions and examples show exemplary embodiments by way of example and are not intended to limit the scope of the disclosure.

When the amount of each component in a composition is mentioned herein, the component may include plural substances. In that case, the amount means the total amount of the plural substances in the composition unless otherwise specified.

Herein. “electrophotographic photoconductor” is also simply referred to as “photoconductor”. Herein, “axial direction” of the charging member means a direction in which the rotation axis of the charging member extends.

Herein, “conductive” means a volume resistivity of 1×10¹⁴ Ωcm or less at 20° C.

Herein, first and second exemplary embodiments are also referred to as “the exemplary embodiment” for features common to these embodiments.

Charging Device

A charging device according, to the exemplary embodiment includes a charging member that includes a conductive substrate, an elastic layer provided on the conductive substrate, and a surface layer provided on the elastic layer and charges an electrophotographic photoconductor by a contact charging method; and a voltage application unit that applies, to the charging member, an AC voltage superimposed on a DC voltage.

In the charging device according to a first exemplary embodiment, the surface layer provided in the charging member contains irregularities-forming particles that have a number particle size distribution with two or more maximum values when observed from the surface of the surface layer.

In the charging device according to a second exemplary embodiment, the surface layer provided in the charging member contains two or ore types of irregularities-forming particles having different volume average particle diameters.

In the current field of electrophotographic technology, there is a demand for development of a small-sized and low-cost electrophotographic apparatus, in which a contact charging method is often adopted for charging. For example, the surface of the charging member for contact charging method may be contaminated with toner particles, external additives, and so on. The contamination with toner particles and external additives, which occurs when using a charging member for contact charging method, is caused by so-called “pass through” of toners and external additives, which remain unreinoved by a photoconductor cleaning unit, at a contact portion between the photoconductor and the charging member. The contaminants originally present on the photoconductor move to the charging member at the contact portion between the photoconductor and the charging member.

A charging, member having irregularities on a surface layer may be used in a contact charging-type charging device for applying an AC voltage superimposed on a DC voltage. In this case, the number of contact points between the photoconductor and the surface layer of the charging member of the charging device may be small, if the irregularities formed on the surface are too large and the number particle size distribution of the irregularities-forming particles has a single maximum value on the large diameter side when the surface layer of the charging member is observed from the surface, or if the irregularities-forming particles in the surface only include large irregularities-forming particles having a large volume average particle diameter. As the number of contact points between the photoconductor and the charging member of the charging device decreases, the distance may increase between the photoconductor and a recessed portion of the surface layer of the charging member having irregularities, so that discharging may occur not only upstream and downstream of the contact portion between the photoconductor and the charging member (at so called pre-nip and post-nip portions) in the rotation direction but also at the contact portion between the photoconductor and the charging member. As a result, the surface of the photoconductor may be more likely to be worn by discharge stress.

On the other hand, in the case where a charging member having irregularities on a surface layer is used in a contact charging-type charging device for applying an AC voltage superimposed on a DC voltage, the number of contact points between the charging device and the photoconductor may be large, if the irregularities formed on the surface are too small and the number particle size distribution of the irregularities-forming particles has a single maximum value on the large diameter side when the surface layer of the charging member is observed from the surface, or if the irregularities-forming particles in the surface only include small irregularities-forming particles having a small volume average particle diameter. As the number of contact points between the photoconductor and the charging member of the charging device increases, the contaminants may become more likely to accumulate on the surface of the charging member, which may cause streaks on images.

In this regard, the amount of discharge to the photoconductor is smaller when using a contact charging-type charging device for applying only DC voltage than when using a contact charging-type charging device for applying AC voltage superimposed on DC voltage. Therefore, the surface of the photoconductor is less likely to he worn particularly when the above charging members are used in the contact charging-type charging device for applying only DC voltage.

Even under these circumstances, the charging members according to the first and second exemplary embodiments having the features mentioned above are less likely to cause streaks on images or wear of the surface of the electrophotographic photoconductor. The reason, although not clear, may be as follows.

In the charging member according to the first exemplary embodiment, the number particle size distribution of the irregularities-forming particles observed from the surface of the surface layer has two or more maximum values, so that the surface layer has a small raised portion formed in a recessed portion between large raised portions. In addition, the surface layer of the charging member according to the second exemplary embodiment contains two or more types of irregularities-forming particles having different volume average particle diameters, so that a small raised portion formed of irregularities-forming particles having small diameters is formed in a recessed portion between large raised portions formed of irregularities-forming particles having large diameters.

In the charging device according to the exemplary embodiment (the first and second exemplary embodiments), therefore, a proper distance is kept between the photoconductor and the recessed portion on the surface of the charging member, so that contaminants remaining on the photoconductor are prevented from migrating to the charging member. In addition, the discharge at the contact portion between the photoconductor and the charging member can be kept low, so that the discharge stress can be kept low. This may prevent streaks on images and wear of the surface of the electrophotographic photoconductor.

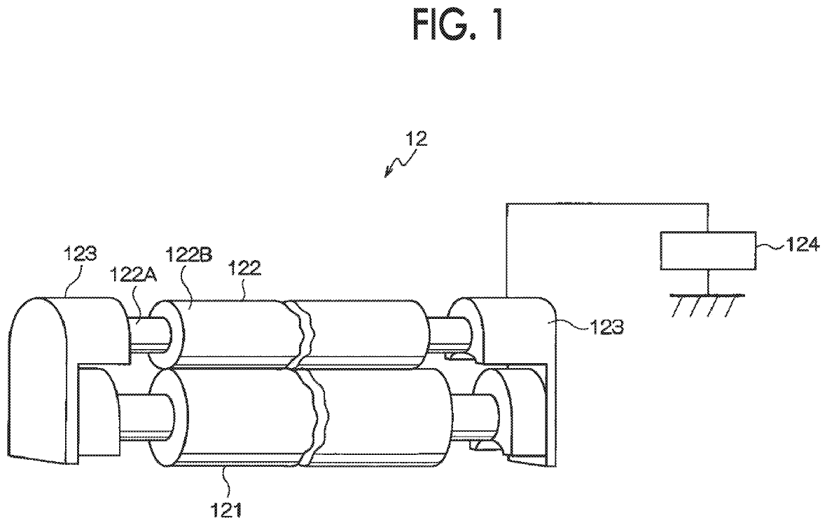

Hereinafter, details of the charging device according to the exemplary embodiment will be described with reference to FIG. 1. FIG. 1 is a schematic perspective view illustrating an example of the charging device according to the exemplary embodiment.

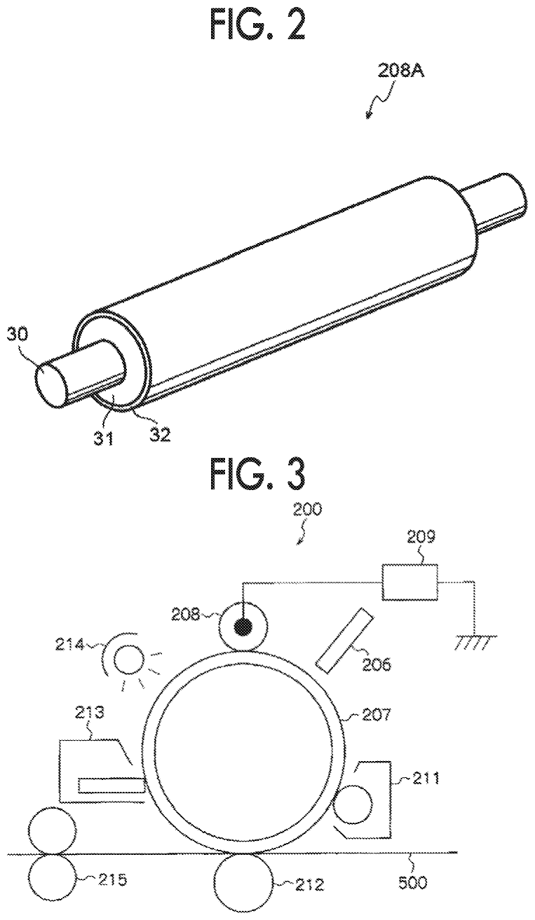

As illustrated in FIG. 1, in a charging device 12 according to the exemplary embodiment, a charging member 121 and a cleaning member 122 are disposed in contact with each other with a specific amount of bite. In addition, both axial end portions of a conductive substrate (30 in FIG. 2) of the charging member 121 and a shaft 122A of the cleaning member 122 are held by a conductive bearing 123 (for example, conductive bearing) so that each member is freely rotatable. One side of the conductive bearing 123 is connected to a power supply 124 (an example of a Voltage application unit). A voltage, obtained by superimposing an AC voltage on a DC voltage is applied to the charging member 121 from the power supply 124. The charging member 121 is, for example, a roll member including a conductive substrate (30 in FIG. 2) and a surface layer (32 in FIG. 2) provided on the conductive substrate (30 in FIG. 2). The cleaning member 122 is, for example, a roll member including a shaft 122A and a foamed elastic layer 122B provided on the outer circumferential surface of the shaft 122A. In the charging device 12 illustrated in FIG. 1, the cleaning member 122 is an optional member.

Next, the conductive bearing and the power supply in the charging device 12 illustrated in FIG. 1 will be described.

The conductive bearing 123 is a member that integrally and rotatable holds the charging member 121 and the cleaning member 122 and keeps the axis distance between the members.

By adjusting the axis distance, the amount of bite between the charging member 121 and the cleaning member 122 is controlled. Specifically, the amount of bite by the cleaning member 122 is adjusted by, for example, pressing both axial end portions of the shaft 122A toward the charging member 121 with a desired load. Then, the foamed elastic layer 122B is pressed against the charging member 121, and the foamed elastic layer 122B is elastically deformed along the peripheral surface of the charging member 121 to form a contact region.

The conductive bearing 123 may be of any material having conductivity and of any form. For example, a conductive bearing or a conductive sliding bearing may be used.

The power supply 124 (an example of the voltage application unit) is a device for charging the charging member 121 and the cleaning member 122 to the same polarity by applying a voltage (in the exemplary embodiment, a voltage obtained by superimposing an AC voltage on a DC voltage) to the conductive bearing 123. A known high voltage power supply device may be used.

It will be understood that the charging device described with reference to FIG. 1 is a non-limiting example according to the exemplary embodiment. A further description may be given below with no reference numerals.

Next, each member constituting the charging device according to the exemplary embodiment will be described.

Charging Member

The charging member in the exemplary embodiment will be described.

The charging member in the exemplary embodiment is a charging member that charges the electrophotographic photoconductor by a contact charging method. The charging member includes, for example, a conductive substrate, an elastic layer provided on the conductive substrate, and a surface layer provided on the elastic layer.

Examples of the shape of the charging member in the exemplary embodiment include, but are not limited to, a roll shape, a brush shape, a belt (tube) shape, and a blade shape. Among these, a roll-shaped charging member as illustrated in FIG. 2, what is called a charging roll, is preferable.

FIG. 2 is a schematic perspective view: illustrating an example of the charging member in the exemplary embodiment. A charging member 208A as illustrated in FIG. 2 includes a conductive substrate 30 which is a hollow or non-hollow cylindrical member, an elastic layer 31 disposed on the outer circumferential surface of the conductive substrate 30, and a surface layer 32 disposed on the outer circumferential surface of the elastic layer 31. The charging member 208A illustrated in FIG. 2 is used, for example, as the charging member 121 in the charging device 12 illustrated in FIG. 1. It will be understood that the charging device in the exemplary embodiment should not be limited to that described With reference to FIG. 2. A further description may be given below with no reference numerals.

The charging member in the first exemplary embodiment contains irregularities-forming particles in the surface layer and has irregularities. When the surface layer is observed from the surface, the irregularities-forming particles in the surface layer have a number particle size distribution with two or more maximum values.

The number particle size distribution of the irregularities-forming particles observed from the surface of the surface layer may be measured as follows. First, measurement samples of the surface layer of the charging member to be measured are collected. Next, the surface of the surface layer is observed with a laser microscope (VK-X150, manufactured by Keyence Corporation), and its image is captured. The image is taken into an image analyzer, and the number distribution of the circle-equivalent diameters of the observed irregularities-forming particles is obtained by the image analysis of the obtained image. Next, based on the distribution, a maximum value P1 on the largest diameter side and a maximum value P2 on the second largest diameter side are obtained. Based on the obtained distribution, a difference (P1−P2) between the maximum values P1 and P2 is obtained.

In the charging member according to the first exemplary embodiment, concerning two or more maximum Values observed from the surface of the surface layer, the particle diameter difference (P1−P2) between the maximum value P1 on the largest diameter side and the maximum value P2 on the second largest diameter side is preferably from 5 μm to 27 μm. P1−P2 is more preferably from 10 μm to 22 μm. When P1−P2 is within the above range, streaks on images can be easily prevented and wear of the surface of the electrophotographic photoconductor can also be easily prevented.

In addition, in the charging member according to the first exemplary embodiment. P1 is preferably in the range of from 10 μm to 32 μm, more preferably in the range of from 20 μm to 32 μm. P2 is preferably in the range of 5 μm to 20 μm, more preferably in the range of from 5 μm to 11 μm. When each of P1 and P2 is within the above range, streaks on images can be easily prevented and wear of the surface of the electrophotographic photoconductor can also be easily prevented.

In the charging, member according to the first exemplary embodiment, concerning two or more maximum values observed from the surface of the surface layer, the ratio (P1/P2) of the height of the maximum value P1 peak on the largest diameter side to the height of the maximum value P2 peak on the second largest diameter side is preferably in the range of from 1.5 to 6, more preferably in the range of from 1.5 to 4. When the ratio (P1/P2) between the heights of the maximum value peaks is within the above range, streaks on images can be easily prevented and wear of the surface of the electrophotographic photoconductor can also be easily prevented.

In the first exemplary embodiment, any method may be used to form the surface layer in which the number particle size distribution of the irregularities-forming particles has two or more maximum values when the surface layer of the charging member is observed from the surface. For example, the irregularities-forming particles for use in the surface layer may be two or more types of irregularities-forming particles having different volume average particle diameters or irregularities-forming particles having two or more maximum values. To prevent streaks on images and wear of the surface of the electrophotographic photoconductor, it is preferable to use a method using two or more types of irregularities-forming particles having different volume average particle diameters. To obtain two or more desired maximum values, a method using two or more types of irregularities-forming particles having different volume average particle diameters is useful.

The charging member in the second exemplary embodiment contains, in the surface layer, two or more types of irregularities-forming particles having different volume average particle diameters. In the charging member according to the second exemplary embodiment, concerning two or more types of irregularities-forming particles having different volume average particle diameters, a difference (R1−R2) between the volume average particle diameter R1 of irregularities-forming particles haying the largest volume average particle diameter and the volume average particle diameter R2 of irregularities-forming particles having the second largest volume average particle diameter is preferably from 5 μm to 25 μm, more preferably from 10 μm to 20 μm. When R1−R2 is within the above range, streaks on images can be easily prevented and wear of the surface of the electrophotographic photoconductor can also be easily prevented.

Among the two or more types of irregularities-forming particles having different volume average particle diameters in the surface layer of the charging member according to the second exemplary embodiment, the irregularities-forming particles having the largest volume average particle diameter preferably have a volume average particle diameter R1 of from 10 μm to 30 μm. RI is more preferably 15 μm or more, still more preferably 20 μm or more. R1 is more preferably 25 μm or less. The irregularities-forming particles having the second largest volume average particle diameter preferably have a volume average particle diameter R2 of from 5 μm to 10 μm. When each of R1 and R2 is within the above range, streaks on images can be easily prevented and wear of the surface of the electrophotographic photoconductor can also be easily prevented.

Concerning the two or more types of irregularities-forming particles having different volume average particle diameters, the ratio (M1/M2) of the weight M1 of irregularities-forming particles having the largest volume average particle diameter to the weight M2 of irregularities-forming particles having the second largest volume average particle diameter is preferably in the range of from 2/20 to 20/10, more preferably in the range of from 2/10 to 10/10. When the weight ratio M1/M2 is within the above range, streaks on images can be easily prevented and wear of the surface of the electrophotographic photoconductor can also be easily prevented.

The volume average particle diameter of all the irregularities-forming particles in the surface layer of the charging member according to the exemplary embodiment is preferably from 6 μm to 25 μm, more preferably from 10 μm to 20 μm. Herein, the volume average particle diameter of all the irregularities-forming particles may refer to a volume average particle diameter obtained when the irregularities-forming particles in the surface layer are measured. For example, the volume average particle diameter of the irregularities-forming particles including two or more types of irregularities-forming particles having different volume average particle diameters may refer to a volume average particle diameter obtained when the two or more types of irregularities-forming particles are measured without distinction between them.

In the exemplary embodiment, a method of measuring the volume average particle diameter of the particles may include cutting the surface layer to be measure to obtain a sample, observing the sample with an electron microscope, measuring the diameters (maximum diameters) of 100 irregularities-forming particles, and calculating the volume average of the measurements (specifically, drawing a cumulative distribution from the small diameter side and determining the volume average particle diameter D50v at cumulative 50%). The volume average particle diameter may also be measured, for example, using Z-tasizer Nano ZS manufactured by Sysmex Corporation.

In the exemplary embodiment the material for the irregularities-forming particles in the surface layer of the charging member may be, but not limited to, inorganic or organic.

Specific examples of the irregularities-forming particles in the surface layer include inorganic particles such as silica particles, alumina particles, and zircon (ZrSiO₄) particles, and resin particles such as polyamide particles, fluororesin particles, and silicone resin particles.

In particular, the irregularities-forming particles in the surface layer are more preferably resin particles, still more preferably polyamide particles, from the viewpoint of making it easier to prevent streaks on images, wear of the surface of the electrophotographic photoconductor, and streak-induced failures. The surface layer may contain a single type of irregularities-forming particles or two or more types of irregularities-forming particles without departing from the gist of the exemplary embodiment. In a case where the surface layer contains two or more types of irregularities-forming particles having different volume average particle diameters, the two or more types are all preferably poly amide particles.

Further, the total content of the irregularities-forming particles in the surface layer is preferably from 5 parts by weight to 30 parts by weight, more preferably from 10 parts by weight to 25 parts by weight based on 100 parts by weight of the binder resin in the surface layer. The total content of the irregularities-forming particles refers to the content of all types of irregularities-forming particles in the surface layer. For example, in a case where the surface layer contains two or more types of irregularities-forming particles having different volume average particle diameters, it means the total content of the two or more types of irregularities-forming particles.

In the charging member according to the exemplary embodiment, only the surface layer may contain the irregularities-forming particles, or both the surface layer and the elastic layer may contain the irregularities-forming particles.

Conductive Substrate

The conductive substrate functions as an electrode and a support for the charging member.

Examples of the conductive substrate include conductive materials such as metals and alloys such as aluminum, copper alloys, and stainless steel; iron plated with chromium, nickel or the like; and conductive resins. In the exemplary embodiment, the conductive substrate functions as an electrode and a support member for the charging roll, and examples of materials thereof include metals such as iron (free cutting steel etc.), copper, brass, stainless steel, aluminum, and nickel. In the exemplary embodiment, the conductive substrate is a conductive rod-shaped member, and examples of the conductive substrate include a member (for example, a resin or a ceramic member) with a plated outer circumferential surface, a member (for example, a resin or a ceramic member) with a conductive agent dispersed therein The conductive substrate may be a hollow member (cylindrical member) or a non-hollow member.

Elastic Layer

The elastic layer is, for example, a conductive layer including an elastic material and a conductive agent. The elastic layer may contain other additives as needed.

The elastic layer may be a single layer or a laminate of plural layers. The elastic layer may be a conductive foamed elastic layer, a conductive non-foamed elastic layer, or a laminate of a conductive foamed elastic layer and a conductive non-foamed elastic layer.

Examples of the elastic material include polyurethane, nitrile rubber, isoprene rubber, butadiene rubber, ethylene-propylene rubber, ethylene-propylene-diene rubber, epichlorohydrin rubber, epichlorohydrin-ethylene oxide rubber, epichlorohydrin-ethylene oxide-allyl glycidyl ether rubber, styrene-butadiene rubber, arrylonitrile-butadiene rubber, chloroprene rubber, chlorinated polyisoprene, hydrogenated polybutadiene butyl rubber, silicone rubber, fluororubber, natural rubber, and elastic materials including any mixture thereof. Preferred elastic materials include polyurethane, silicone rubber, nitrile rubber, epichlorohydrin rubber, epichlorohydrin-ethylene oxide rubber, epichlorohydrin-ethylene oxide-allyl glycidyl ether rubber, ethylene-propylene-diene rubber, acrylonitrile-butadiene rubber, and elastic materials including any mixture thereof.

The conductive agent may be an electron conductive agent or an ion conductive agent.

Examples of the electron conductive agent include powders such as carbon black such as furnace black, thermal black, channel black, ketjen black, acetylene black, and color black; pyrolytic carbon; graphite; metals and alloys such as aluminum, copper, nickel, and stainless steel; metal oxides such as tin oxide, indium oxide, titanium oxide, tin oxide-antimony oxide solid solutions, and tin oxide-indium oxide solid solutions; and materials obtained by performing a conductive treatment on the surface of an insulating material.

Examples of the ion conductive agent include perchlorates or chlorates such as tetraethyl ammonium, lauryl trimethyl ammonium. and benzyl trialkyl ammonium; alkaline metals such as lithium and magnesium; and perchlorate or chlorate such as alkaline earth metal.

The conductive agents may be used singly, or a combination of two or more thereof may be used.

The conductive agent preferably has an average primary particle diameter of for example, from 1 nm to 200 nm.

The content of the electron conductive agent in the elastic layer is preferably from 1 part by weight to 30 parts by weight, more preferably from 15 parts by weight to 25 parts by weight based on 100 parts by weight of the elastic material.

The content of the ion conductive agent in the elastic layer is preferably 0.1 parts by eight to 5 parts by weight, more preferably from 0.5 parts by weight to 3 parts by weight based on 100 parts by weight of the elastic material.

The average particle diameter may be determined by cutting the elastic layer to obtain a sample, Observing the sample with an electron microscope, measuring the diameters (maximum diameters) of 100 conductive agent particles, and averaging the measured diameters. The average particle diameter may also be measured, for example, using Zetasizer Nano ZS manufactured by Sysmex Corporation.

In the case of the electron conductive agent, the content of the conductive agent is preferably, but not limited to, from 1 part by weight to 30 parts by weight, more preferably from 15 parts by weight to 25 parts by eight, based on 100 parts by weight of the elastic material. In the case of the ion conductive agent, the content is preferably from 0.1 parts by weight to 5.0 parts by weight, more preferably from 0.5 parts by weight to 3.0 parts by weight, based on 100 parts by weight of the elastic material.

Examples of other additives that may be mixed into the elastic layer include a softener, a plasticizer, a curing agent a vulcanizing agent, a vulcanization accelerator, a vulcanization accelerating auxiliary agent, an antioxidant, a surfactant, a coupling agent, a filler (such as silica, calcium carbonate, and clay mineral).

The thickness of the elastic layer is preferably from 1 nm to 10 mm, more preferably 2 mm to 5 mm.

The volume resistivity of the elastic layer is preferably from 1×10³ Ωcm to 1×10¹⁴ Ωcm.

The volume resistivity of the elastic layer may be a value measured by the following method.

A sheet-like measurement sample is taken from the elastic layer. A voltage adjusted so that the electric field (applied voltage/composition sheet thickness) becomes 1000 V/cm is applied to the measurement sample for 30 seconds using a measurement jig (R12702A/B resistivity chamber: manufactured by Advantest Corporation) and a high resistance measuring instrument (R8340A digital high resistance/microammeter: manufactured by Advantest Corporation) in accordance with JIS K 6911(1995), which is followed by calculation from the current value using the following equation.

Volume resistivity (Ωcm)=(1963×applied voltage (V))/(current value (A)×thickness of measurement sample (cm))

The elastic layer may be formed on the conductive substrate, for example, by a method that includes co-extruding an elastic layer-forming composition including a mixture of an elastic material, a conductive agent, and other additives and a cylindrical conductive substrate with an extruder to form a layer of an elastic layer-forming composition on the outer circumferential surface of the conductive substrate and then heating and crosslinking the layer of the elastic layer-forming composition to form an elastic layer; or by a method that includes extruding an elastic layer-forming composition including a mixture of an elastic material, a conductive agent, and other additives onto the outer circumferential surface of an endless belt-shaped conductive substrate to form a layer of an elastic layer-forming, composition on the outer circumferential surface of the conductive substrate and then heating and crosslinking the layer of the elastic layer forming composition to form an elastic layer. The conductive substrate may have a bonding layer on the outer circumferential surface thereof.

Surface Layer

The charging member according to the exemplary embodiment further includes a surface layer on the elastic layer. The surface layer is, for example, a resin-containing layer. The surface layer may contain other additives as needed.

Examples of the binder resin that may be used for the surface layer include urethane resin, polyester, phenol, acrylic, polyurethane, epoxy resin, and cellulose.

In order to adjust the resistivity of the surface layer to an appropriate value, conductive particles may often be added.

The conductive particles preferably have a particle diameter of 3 μm or less and a volume resistivity of 10⁹ Ωcm or less. For example, particles including a metal oxide such as tin oxide, titanium oxide, or zinc oxide, or an alloy thereof or carbon black may be used.

The thickness of the surface layer is preferably from 2 μm to 10 μm, more preferably from 3 μm to 8 μm in view of preventing fog over a long period of time.

The volume resistivity of the surface layer is preferably from 1×10⁵ Ωcm to 1×10⁸ Ωcm.

The surface layer may be formed using a general coating method such as a roll coating method, a blade coating method, a wire bar coating method, a spraying method, a dip coating method, a bead coating method, an air knife coating method, or a curtain coating method. The roll coating, method, which does not cause end dripping, is preferably used to make the vicinity of the end portion thicker than the vicinity of the center portion. The dip coating method is also preferably used because it can efficiently form a less-defective film although it may cause end dripping.

Bonding Layer

The charging member according to the exemplary embodiment may include a bonding layer between the conductive substrate and the elastic layer.

Such a bonding, layer interposed between the elastic layer and the conductive substrate may be a resin layer, specifically, a resin layer of polyolefin, acrylic resin, epoxy resin, polyurethane, nitrile rubber, chlorine rubber, vinyl chloride resin, vinyl acetate resin, polyester, phenol resin, or silicone. The bonding layer may contain a conductive agent (for example, the electron conductive agent or ion conductive agent).

The thickness of the bonding layer is preferably from 1 μm to 100 μm, more preferably from 2 μm to 50 μm, particularly preferably from 5 μm to 20 μm, in view of adhesion.

Image Forming Apparatus and Process Cartridge

The image forming apparatus according to the exemplary embodiment includes a charging device including: a charging member that has a specific surface layer and charges an electrophotographic photoconductor by a contact charging method; and a voltage application unit that applies, to the charging member, an AC voltage superimposed on a DC voltage.

Specifically, the image forming apparatus according to the exemplary embodiment includes an electrophotographic photoconductor, a charging device according to the exemplary embodiment that charges a surface of the electrophotographic photoconductor, a developing device that forms an electrostatic latent image on the charged surface of the electrophotographic photoconductor, a latent image forming device that forms a latent image on the charged surface of the electrophotographic photoconductor, a developing device that develops the latent image formed on the surface of the electrophotographic photoconductor with a developer containing toner to form a toner image on the surface of the electrophotographic photoconductor, and a transfer device that transfers the toner image formed on the surface of the electrophotographic photoconductor to a recording, medium.

The image forming apparatus according to the exemplary embodiment may further include at least one selected from a fixing device that fixes a toner image on a recording medium; a cleaning device that cleans the surface of the photoconductor before charging and after the transfer of the toner image; and an erasing device that erases charges by irradiating the surface of the photoconductor with light before charging and after the transfer of the toner image.

The image forming apparatus according to the exemplary embodiment may be any one of a direct-transfer type apparatus that directly transfers the toner image formed on the surface of the electrophotographic photoconductor to the recording medium; and an intermediate transfer type apparatus that primarily transfers the toner image formed on the surface of the electrophotographic photoconductor to a surface of an intermediate transfer body, and secondarily transfers the toner image transferred to the surface of the intermediate transfer body to the surface of the recording medium.

The process cartridge according to the exemplary embodiment is a cartridge that can be attached to and detached from the image forming apparatus, and includes a charging device including a charging member that has a specific surface layer and charges an electrophotographic photoconductor by a contact charging method and a voltage application unit that applies, to the charging member, an AC voltage superimposed on a DC voltage. Specifically, the process cartridge according to the exemplary embodiment includes an electrophotographic photoconductor and the charging device according to the exemplary embodiment and is attachable to and detachable from the image forming apparatus.

The process cartridge according to the exemplary embodiment may further include at least one selected from the developing device, the cleaning, device for the photoconductor, an erasing device for the photoconductor, and the transfer device.

Hereinafter, the configurations of the charging device, the image forming apparatus, and the process cartridge according to the exemplary embodiment will be described with reference to the drawings.

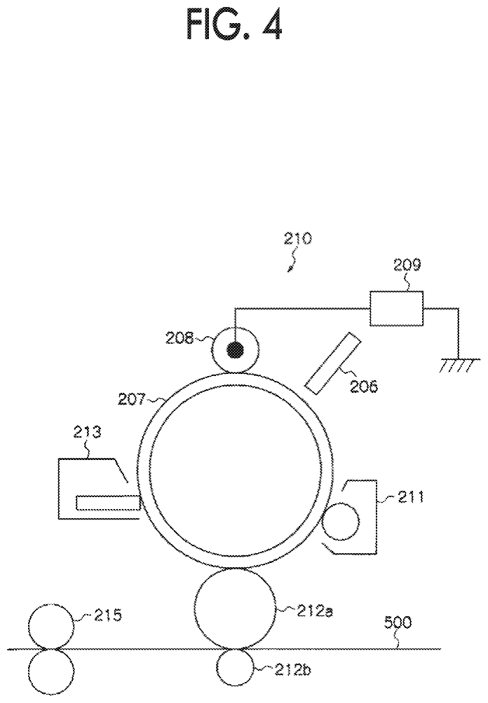

FIG. 3 is a schematic configuration diagram illustrating an example of the image forming apparatus according to the exemplary embodiment; FIG. 3 is a schematic view illustrating a direct transfer-type image forming apparatus. FIG. 4 is a schematic configuration diagram illustrating another example of the image forming apparatus according to the exemplary embodiment; FIG. 4 is a schematic view illustrating an intermediate transfer-type image forming apparatus.

The image forming apparatus 200 illustrated in FIG. 3 includes an electrophotographic photoconductor (also referred to simply as “photoconductor”) 207; a charging device 208 that charges the surface of the photoconductor 207; a power supply 209 (as an example of voltage application unit) connected to the charging device 208; an exposure device 206 that exposes the surface of the photoconductor 207 to light to form a latent image; a developing device 211 that develops the latent image on the photoconductor 207 with a developer containing toner; a transfer device 212 that transfers the toner image on the photoconductor 207 to a recording medium 500, a fixing device 215 that fixes the toner image on the recording medium 500; a cleaning device 213 that removes toner remaining on the photoconductor 207; and an erasing device 214 that erases the charge on the surface of the photoconductor 207. The erasing device 214 may not be provided.

The image forming apparatus 210 illustrated in FIG. 4 includes the photoconductor 207, the charging device 208, the power supply 209 (as an example of voltage application unit), the exposure device 206, the developing device 211, a primary transfer member 212a and a secondary transfer member 212b that transfer the toner image on the photoconductor 207 to the recording medium 500, the fixing device 215, and the cleaning device 213. Similar to the case of the image forming apparatus 200, the image forming apparatus 210 may not include the erasing device.

The charging device 208 is a contact charging-type charging device that includes a roll-shaped charging member and is brought into contact with the surface of the photoconductor 207 to charge the surface of the photoconductor 207. To the charging device 208, a voltage obtained by superimposing an AC voltage on a DC voltage is applied from the power supply 209 as an example of the voltage application unit. The charging device 208 may be one according to the exemplary embodiment. For example, the charging device 208 may be the charging device 12 illustrated in FIG. 1.

Examples of the exposure device 206 include optical devices having a light source such as semiconductor laser or a light emitting diode (LED).

The developing device 211 is a device that supplies toner to the photoconductor 207. The developing device 211 brings a roll-shaped developer holding member into contact with or in proximity to the photoconductor 207, for example, and causes toner to adhere to the latent image on the photoconductor 207 to form a toner image.

Examples of the transfer device 212 include a corona discharge generator and a conductive roll pressed against the photoconductor 207 with the recording medium 500 interposed therebetween.

The primary transfer member 212a may be, for example, a conductive roll that rotates while being in contact with the photoconductor 207. The secondary transfer member 212b may be, for example, a conductive roll that presses the primary transfer member 212a with the recording medium 500 interposed therebetween.

The fixing device 215 may be, for example, a heating fixing device including a heating roll and a pressure roll pressed against the heating roll.

The cleaning deice 213 may be a device having a blade, a brush, or a roll as a cleaning member. Examples of the material of the cleaning blade include urethane rubber, neoprene rubber, and silicone rubber.

The erasing device 214 is, for example, a device that erases the residual potential on the photoconductor 207 by irradiating the surface of the photoconductor 207 with light after the transfer. The erasing device 214 may not be provided.

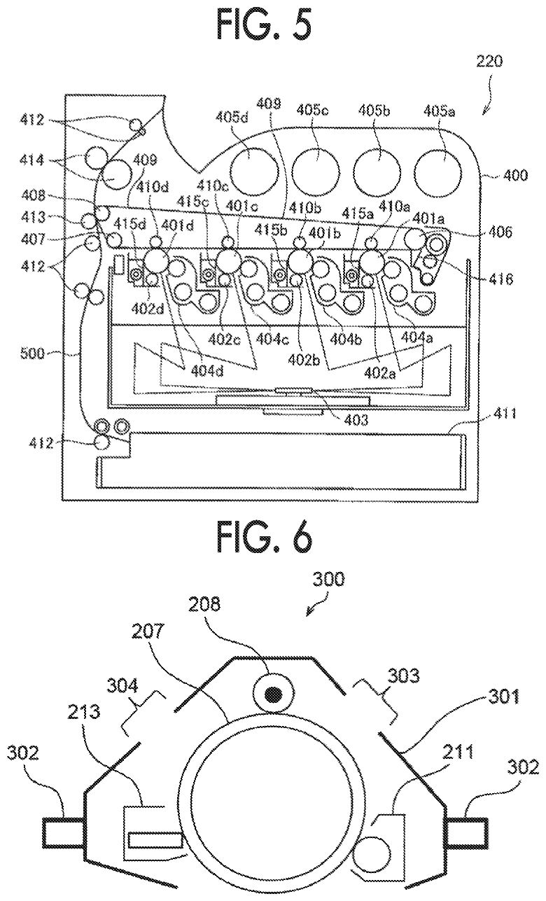

FIG. 5 is a schematic diagram illustrating another example of the image forming apparatus according, to the exemplary embodiment. FIG. 5 is a schematic view illustrating a tandem and intermediate transfer-type image forming apparatus having four image forming units arranged in parallel.

The image forming apparatus 220 includes four image forming units corresponding to the respective colors of toners in a housing 400, an exposure device 403 having a laser light source, an intermediate transfer belt 409 a secondary transfer roll 413, a fixing device 414 and a cleaning device having a cleaning blade 416.

The four image forming units have the same configuration. Therefore, the configuration of the image forming unit including a photoconductor 401a will be described as a representative.

In the vicinity of the photoconductor 401a, a charging roll 402a, a developing device 404a, a primary transfer roll 410a, and a cleaning blade 415a are arranged in order in the rotational direction of the photoconductor 401a. The primary transfer roll 410a is pressed against the photoconductor 401a via the intermediate transfer belt 409. The toner stored in a toner cartridge 405a is supplied to the developing device 404a.

The charging roll 402a is a contact charging-type charging member that is brought into contact with the surface of the photoconductor 401a to charge the surface of the photoconductor 401a. An AC voltage superimposed on DC voltage is applied from the power supply (not shown) to the charging roll 402a.

The intermediate transfer belt 409 is stretched by a drive roll 406, a tension roll 407, and a back roll 408, and travels as these rolls rotate.

The secondary transfer roll 413 is disposed to press against the back roll 408 via the intermediate transfer belt 409.

The fixing, device 414 is, for example, a heating fixing device including a heating roll and a pressure roll.

The cleaning blade 416 is a member for removing the toner remaining on the intermediate transfer belt 409. The cleaning blade 416 is disposed downstream of the back roll 408 and removes toner remaining on the intermediate transfer belt 409 after the transfer.

A tray 411 for storing the recording medium 500 is provided in the housing 400. The recording medium 500 in the tray 411 is transported to the contact portion between the intermediate transfer belt 409 and the secondary transfer roll 413 by the transport roll 412, and further transported to the fixing device 414, and an image is formed on the recording medium 500. The recording medium 500 after image formation is output outside the housing 400.

FIG. 6 is a schematic diagram illustrating an example of the process cartridge according to the exemplary embodiment. The process cartridge 300 illustrated in FIG. 6 is detachably mounted to an image forming apparatus main body including, for example, an exposure device, a transfer device, and a fixing device.

In the process cartridge 300, the photoconductor 207, the charging device 208, the developing device 211, and a cleaning device 213 are integrated in a housing 301. The housing 301 is provided with a mounting rail 302 to be detachably attached to the image forming apparatus, an opening 303 for exposure, and an opening 304 for charge erasing exposure.

The charging device 208 in the process cartridge 300 is a contact charging-type charging device that includes a roll-shaped charging member and is brought into contact with the surface of the photoconductor 207 to charge the surface of the photoconductor 207. When the process cartridge 300 is mounted to the image forming apparatus and image formation is performed, an AC voltage superimposed on a DC voltage is applied from the power supply (not shown) to the charging device 208.

Developer and Toner

Any developer may be used in the image forming apparatus according to the exemplary embodiment. The developer may be a one-component developer containing only toner, or a two-component developer including a mixture of a toner and a carrier.

The developer may contain any type of toner. The toner includes, for example, a binder resin, a colorant, and a release agent. Examples of the binder resin in the toner include polyester resin and styrene-acrylic resin.

External additives may be added to the toner. Examples of the external additive for the toner include inorganic fine particles such as silica, titania, and alumina.

The toner may be produced by forming loner particles and adding an external additive to the toner particles. Examples of the method of producing the toner particles include a kneading and pulverization method, an aggregation and coalescence method, a suspension polymerization method, and a dispersion polymerization method. The toner particles may have a single-layer structure or what is called a core-shell structure composed of a core (core particle) and a coating layer (shell layer) provided on the core.

The volume average particle diameter (D50v) of the toner particles is preferably 2 μm to 10 μm, more preferably from 4 μm to 8 μm.

The two-component developer may contain any type of carrier. Examples of the carrier include a coated carrier including a magnetic powder, as a core material, with the surface coated with a resin, a magnetic powder dispersion carrier including a matrix resin and a magnetic powder dispersed in the matrix, and a resin-impregnated carrier including a porous magnetic powder impregnated with a resin.

The mixing ratio (weight ratio) of the toner to the carrier in the two-component developer is preferably toner:carrier=from 1:100 to 30:100, more preferably from 3:100 to 20:100.

### EXAMPLES

Hereinafter, the exemplary embodiments of the disclosure will be described in detail with reference to examples, which are not intended to limit the exemplary embodiments of the disclosure. In the description below, “parts” is by weight unless otherwise specified.

Production of Charging Member

Production of Charging Roll 1

Preparation of Substrate

A conductive substrate having a diameter of 8 mm and made of SUS303 is prepared.

Formation of Bonding Layer

Subsequently, after the following materials are mixed in a ball mill for one hour, a bonding layer having a thickness of 10 μm is formed on the substrate surface by brushing. Chlorinated polypropylene resin (maleic anhydride chlorinated polypropylene resin, SUPERCHLON 930, produced by Nippon Paper Industries Co., Ltd.): 100 parts

Epoxy resin (EP 4000, manufactured by ADEKA Corporation): 10 parts

Conductive agent (CARBON BLACK, KETJEN BLACK EC, produced by Ketjenblack International Company): 2.5 parts

Toluene or xylene is used for viscosity adjustment.

Formation of Elastic Layer
Epichlorohydrin rubber (HYDRIN73106, produced by ZEON CORPORATION): 100 parts by weight
Carbon black (Asahi #60, produced by Asahi Carbon Co., Ltd.): 6 parts by weight
Calcium carbonate (WHITON SB, Shiraishi Calcium Kaisha, Ltd.): 20 parts by weight
Ion conductive agent (BTEAC, manufactured by Lion Corporation): 5 parts by weight
Vulcanization accelerator: stearic acid (produced by NOF Corporation): 1 part by weight
Vulcanizing agent: sulfur (VULNOC R, produced by Ouchi Shinko Chemical Industrial Co., Ltd.): 1 part by weight
Vulcanization accelerator: Zinc oxide: 1.5 parts by weight

A mixture with the composition shown above is kneaded with an open roll. Using an extruder, the mixture is then extruded on the surface of a conductive support having a diameter of 8 mm formed of SUS303 with a bonding layer interposed therebetween to form a roll having a diameter of 12 mm. The roll is heated at 175° C. for 70 minutes, so that an elastic layer (a conductive elastic layer) is obtained.

Formation of Surface Layer
Binder resin: N-methoxymethylated nylon 1 (trade name F30K, produced by Namariichi Co., Ltd.): 100 parts by weight
Conductive agent carbon black (trade name: MONAHRCH 1000, produced by Cabot Corporation): 15 parts by weight
Irregularities-forming particles 1: polyamide particles (volume average particle diameter 30 μm, polyamide 12, produced by Arkema S.A.): 10 parts by weight
Irregularities-forming particles 2: polyamide particles (volume average particle diameter 5 μm, polyamide 12, produced by Arkema S.A.): 10 parts by weight

A mixture with the composition shown above is diluted with methanol and then dispersed using a bead mill under the following conditions.
Bead material: Glass
Bead diameter: 1.3 mm
Propeller speed: 2,000 rpm
Dispersion time: 60 minutes

The resulting dispersion is applied by dip coating to the surface of the conductive elastic layer and then dried by heating at 150° C. for 30 minutes to form a surface layer having a thickness of 10 μm, so that a charging roll 1 is obtained.

Production of Charging Roll 2

A charging roll 2 is obtained similarly to the production of the charging roll 1 except that the irregularities-forming particles 2 are polyamide particles (volume average particle diameter 10 μm, Polyamide 12, produced by Arkema S.A.): 10 parts by weight.

Production of Charging Roll 3

A charging roll 3 is obtained similarly to the production of the charging roll 1 except that the irregularities-forming particles 1 are polyamide particles (volume average particle diameter 20 μm, Polyamide 12, produced by Arkema S.A.): 10 parts by weight, and the irregularities-forming particles 2 are polyamide particles (volume average particle diameter 5 μm, Polyamide 12, produced by Arkema S.A.): 10 parts by weight.

Production of Charging Roll 4

A charging roll 4 is obtained similarly to the production of the charging roll 2 except that the irregularities-forming particles 1 are polyamide particles volume average particle diameter 20 μm, Polyamide 12, produced by Arkema S.A.): 10 parts by weight.

Production of Charging Roll 5

A charging roll 5 is obtained similarly to the production of the charging roll 1 except that the irregularities-forming particles 1 are polyamide particles (volume average particle diameter 10 μm, Polyamide 12, produced by Arkema S.A.): 10 parts by weight.

Production of Charging Rolls 6 and 7

A charging roll 6 and a charging roll 7 are obtained similarly to the production of the charging roll 1 except that the ratio (weight ratio) of the irregularities-forming particles 1 to the irregularities-forming particles 2 is changed as shown in Table 1.

Production of Charging Roll 8

A charging roll 8 is obtained similarly to the production of the charging roll 1 except that the types of the irregularities-forming particles and the irregularities-forming particles 2 and the volume average particle diameters thereof are changed according to Table 1.

Production of Charging Rolls C1 and C2

A charging roll CI is obtained similarly to the production of the charging, roll 1 except that only the irregularities-forming particles 1 are used. A charging roll C2 is obtained similarly to the production of the charging roll 1 except that only the irregularities-forming particles 2 are used.

### Examples 1 to 8 and Comparative Examples 1 and 2

Production of Charging Device

Each charging roll obtained above is mounted to a charging device that includes a voltage application unit for applying, to the charging member, a voltage obtained by superimposing an AC voltage on a DC voltage and charges the surface of the electrophotographic photoconductor by a contact charging method, so that a charging device of each example is obtained.

### Reference Example 1

The charging roll CI obtained above is mounted to a charging device that includes a voltage application unit for applying only an AC voltage to the charging member, and charges the surface of the electrophotographic photoconductor by a contact charging method, so that a charging device of a reference example is obtained.

Evaluation of Streaks on Image

The charging device obtained in each of the examples and the comparative examples is incorporated into an image forming apparatus (modified DocuCentre-VC 7776). From the apparatus, 260,000 A4 halftone images having an image density of 20% are output under low-temperature, low-humidity conditions (temperature 10° C. and humidity 15 RH %), and then one halftone image having an image density of 60% is output. The level of charging roll contamination-induced streaks on the output halftone image with an image density of 60% is determined to evaluate the image quality sustainability on a scale of G0 to G3. G0 to G2 levels are acceptable for operation.

Evaluation of Wear of Photoconductor Surface

After the evaluation of streaks on the image, the thickness of the photoconductor is measured with an eddy current thickness tester (Fisherscope MMS), and the wear-induced reduction in thickness is divided by the number of photoconductor running cycles to calculate a wear rate. A lower wear rate means a smaller amount of wear.

TABLE 1

| | | Surface layer | | | | | | |
|---|---|---|---|---|---|---|---|---|
| | | Irregularities-forming particles 1 | | | Irregularities-forming particles 2 | | | |
| | | | | | | Volume average | | |
| | | | Volume particle | | | particle | | P1 − |
| | Charging | | diameter R1 | Number of parts | | diameter R2 | Number of parts | P2 |
| | roll No. | Types | μm | Parts by weight | Types | μm | Parts by weight | μm |
| Example 1 | 1 | PA | 30 | 10 | PA | 5 | 10 | 25 |
| | | particles | | | particles | | | |
| Example 2 | 2 | PA | 30 | 10 | PA | 10 | 10 | 20 |
| | | particles | | | particles | | | |
| Example 3 | 3 | PA | 20 | 10 | PA | 5 | 10 | 15 |
| | | particles | | | particles | | | |
| Example 4 | 4 | PA | 20 | 10 | PA | 10 | 10 | 10 |
| | | particles | | | particles | | | |
| Example 5 | 5 | PA | 10 | 10 | PA | 5 | 10 | 5 |
| | | particles | | | particles | | | |
| Example 6 | 6 | PA | 10 | 20 | PA | 5 | 10 | 5 |
| | | particles | | | particles | | | |
| Example 7 | 7 | PA | 30 | 2 | PA | 5 | 20 | 25 |
| | | particles | | | particles | | | |
| Example 8 | 8 | Silica | 20 | 10 | Silica | 10 | 10 | 10 |
| | | particles | | | particles | | | |
| Comparative | C1 | PA | 30 | 20 | — | — | — | — |
| Example 1 | | particles | | | | | | |
| Comparative | C2 | — | — | — | PA | 5 | 20 | — |
| Example 2 | | | | | particles | | | |
| Reference | C1 | PA | 30 | 20 | — | — | — | — |
| Example 1 | | particles | | | | | | |

| | Surface layer | | | | | |
|---|---|---|---|---|---|---|
| | Number particle size distribution | | | | | |
| | | Local maximum | Second | | | |
| | Number | value P1 on | local | | Evaluation | |
| | of local | largest | maximum | P1 − | | Rate of wear of |
| | maximum | diameter side | value P2 | P2 | Steaks | photoconductor |
| | values | μm | μm | μm | on image | (nm/kcyc) |
| Example 1 | 2 | 32.0 | 5.5 | 26.5 | G0 | 29 |
| Example 2 | 2 | 32.0 | 11 | 21.0 | G0 | 26 |
| Example 3 | 2 | 20.5 | 5.5 | 15.0 | G1 | 24 |
| Example 4 | 2 | 20.5 | 11 | 9.5 | G1 | 23 |
| Example 5 | 2 | 11.0 | 5.5 | 5.5 | G2 | 22 |
| Example 6 | 2 | 11.0 | 5.5 | 5.5 | G1 | 23.0 |
| Example 7 | 2 | 32.0 | 5.5 | 26.5 | G1 | 27.0 |
| Example 8 | 2 | 20.5 | 11.0 | 9.5 | G1 | 23.0 |
| Comparative | 1 | 32.0 | — | — | G0 | 33 |
| Example 1 | | | | | | |
| Comparative | 1 | — | 5.5 | — | G3 | 22 |
| Example 2 | | | | | | |
| Reference | 1 | 32.0 | — | — | G0 | 8 |
| Example 1 | | | | | | |

In the table, the term “PA particles” represents polyamide particles.

The evaluation results show that the results of evaluation of streaks on the image and wear of the photoconductor surface are better in the examples than in the comparative examples.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A charging device comprising:
a charging member that charges an electrophotographic photoconductor by a contact charging method and includes a conductive substrate, an elastic layer provided on the conductive substrate, and a surface layer that is provided on the elastic layer and contains irregularities-forming particles that have a number particle size distribution with two or more maximum values when observed from a surface of the surface layer; and
a voltage application unit that applies, to the charging member, an AC voltage superimposed on a DC voltage.

2. The charging device according to claim 1, wherein
the two or more maximum values of the irregularities-forming particles include a maximum value P1 on a largest diameter side and a maximum value P2 on a second largest diameter side, and a difference (P1−P2) between the maximum values P1 and P2 is from 5 μm to 27 μm.

3. The charging device according to claim 2, wherein
the difference (P1−P2) between the P1 and P2 values is from 10 μm to 22 μm.

4. The charging device according to claim 2, wherein
the P1 value is from 10 μm to 32 μm and the P2 value is from 5 μm to 11 μm.

5. A charging device comprising:
a charging member that charges an electrophotographic photoconductor by a contact charging method and includes a conductive substrate, an elastic layer provided on the conductive substrate, and a surface layer that is provided on the elastic layer and contains two or more types of irregularities-forming particles having different volume average particle diameters; and
a voltage application unit that applies, to the charging member, an AC voltage superimposed on a DC voltage.

6. The charging device according to claim 5, wherein
the two or more types of irregularities-forming particles having different volume average particle diameters include irregularities-forming particles having a largest volume average particle diameter R1 and irregularities-forming particles having a second largest volume average particle diameter R2, and a difference (R1−R2) between the volume average particle diameters R1 and R2 is from 5 μm to 25 μm.

7. The charging device according to claim 6, wherein
the difference (R1−R2) between the average particle diameters R1 and R2 is from 10 μm to 20 μm.

8. The charging device according to claim 6, wherein
the average particle diameter R1 is from 10 μm to 30 μm, and the average particle diameter R2 is from 5 μm to 10 μm.

9. The charging device according to claim 1, wherein
the irregularities-forming particles are polyamide particles.

10. The charging device according to claim 1, wherein
the surface layer has a total content of the irregularities-forming particles of 5 parts by weight to 30 parts by weight based on 100 parts by weight of a binder resin contained in the surface layer.

11. A process cartridge comprising:
an electrophotographic photoconductor; and
the charging device according to claim 1,
the process cartridge being attachable to and detachable from an image forming apparatus.

12. An image forming apparatus comprising:
an electrophotographic photoconductor;
the charging device according to claim 1 that charges a surface of the electrophotographic photoconductor;
a developing device'that forms an electrostatic image on the charged surface of the electrophotographic photoconductor;
a latent image forming device that forms a latent image on the charged surface of the electrophotographic photoconductor;
a developing device that develops the latent image formed on the surface of the electrophotographic photoconductor with a developer containing toner to form a toner image on the surface of the electrophotographic photoconductor, and
a transfer device that transfers the toner image formed on the surface of the electrophotographic photoconductor to a recording, medium.
